(19) United States
(12) Patent Application Publication
(10) Pub. No.: US 2002/0036887 A1
(43) Pub. Date: Mar. 28, 2002

(54) Electronic apparatus

(76) Inventors: Yasuyuki Horii, Ome-shi (JP); Takumi Omura, Tachikawa-shi (JP)

Correspondence Address: Finnegan, Henderson, Farabow,, Garrett & Dunner, L.L.P., 1300 I Street, N.W., Washington, DC, 20005-3315, US

(21) Appl. No.: 09/949,579

(22) Filed: Sep. 12, 2001

(30) Foreign Application Priority Data
Sep. 13, 2000 (JP) 2000-278706

(51) Int. Cl. G06F 1/16

(52) U.S. Cl. 361/683

(57) ABSTRACT

An apparatus body of a personal computer is provided with a card loading portion and a floppy disc drive. The card loading portion includes a card slot, opening in a side wall of the apparatus body and capable of receiving a card-type electronic component, and a push-type eject lever located side by side with the card slot on the side wall of the apparatus body. A front panel of the floppy disc drive is located in contact with the card loading portion and constitutes a part of the side wall. The front panel is formed having a recess, which is located side by side with the eject lever on the front panel and used in ejecting the eject lever.

### CROSS-REFERENCE TO RELATED APPLICATIONS

This application is based upon and claims the benefit of priority from the prior Japanese Patent Application No. 2000-278706, filed Sep. 13, 2000, the entire contents of which are incorporated herein by reference.

### BACKGROUND OF THE INVENTION

1. Field of the Invention

The present invention relates to an electronic apparatus such as a portable personal computer, and more particularly, to an electronic apparatus provided with a card loading portion through which a card-type electronic component for function expansion can be loaded into the apparatus.

2. Description of the Related Art

Recently, there have been spread compact portable computers such as book-type personal computers, so-called mobile computers, etc. The computers of these types have been reduced in body size to be improved in portability, and nevertheless, require higher performance and multifunctional properties.

In general, one such computer comprises a substantially rectangular flat apparatus body and a display unit rockably mounted on the apparatus body. The apparatus body contains therein a printed circuit board, which is amounted with a lot of electronic components, and a hard disc drive, floppy disc drive, optical disc drive, etc. for use as information storage devices.

The floppy disc drive and the optical disc drive are separately unitized and removably attached to the apparatus body. The floppy disc drive, for example, includes a resin casing that covers the drive body. A front panel of the casing is exposed on a side wall of the apparatus body and constitutes a part of the side wall. The front panel is provided with a loading aperture through which a floppy disc can be loaded into and unloaded from the apparatus body.

Further, the computer of this type has a card slot as a card loading portion that opens in the side wall of the apparatus body. The functions of the apparatus can be expanded if a PC card, such as a modem card, memory card, or interface card, is inserted into the card slot. An eject lever for taking out the PC card from the card slot is located side by side with the card slot on the side wall of the apparatus body.

Push-type eject levers have recently be provided as eject levers for the purpose. When the computer is being carried about or is not in operation, these eject levers are pushed in the apparatus body so that their respective distal ends are substantially flush with the side wall of the apparatus body. If one of the eject levers is pushed in once, in ejecting the PC card, it projects from the side wall of the apparatus body. The PC card can be ejected as the projected eject lever is pushed in again toward the apparatus body.

In order to allow the eject lever to be pushed in smoothly, the side wall of the apparatus body is provided with a recess that is located adjacent to the eject lever and can receive a finger.

To facilitate the improvement of the performance of the computer and ensure multifunctional properties, the apparatus body is provided with a large number of components, and some of these components are exposed on a side face, rear face, etc. of the apparatus body so that the spaces can be saved. For example, the card slot, eject lever, floppy disc drive, etc. are arranged side by side on the side face of the apparatus body.

In the case where the apparatus body is provided with the recess for the operation of the eject lever, as described above, however, a space must be secured for the formation of the recess in the side wall of the apparatus body, thus constituting a hindrance to the miniaturization of the computer, especially of the apparatus body.

### BRIEF SUMMARY OF THE INVENTION

The present invention has been contrived in consideration of these circumstances, and its object is to provide an electronic apparatus capable of being reduced in size without lowering the operating efficiency of elect levers,

In order to achieve the above object, in an electronic apparatus according to an aspect of the present invention, a recess for the operation of an eject lever is formed on a front panel of a drive unit that is exposed on a wall portion of an apparatus body.

An electronic apparatus according to an aspect of the invention comprises: an apparatus body having a wall portion; a card loading portion including a card slot, formed in the apparatus body, opening in the wall portion of the apparatus body, and capable of receiving a card-type electronic component, and an eject lever located side by side with the card slot on the wall portion of the apparatus body and configured to take out the electronic component from the card slot; and a drive unit provided on the apparatus body. The drive unit includes a front panel, located next to the card loading portion and constituting a part of the wall portion, and a recess located side by side with the eject lever on the front panel and capable of receiving a finger.

An electronic apparatus according to another aspect of the invention comprises: a substantially rectangular apparatus body having a side wall; a display unit rockably mounted on the apparatus body; a card loading portion including a card slot, formed in the apparatus body, opening in the side wall, and capable of receiving a card-type electronic component, and a push-type eject lever located side by side with the card slot on the side wall of the apparatus body and configured to take out the electronic component from the card slot; and a drive unit provided on the apparatus body. The drive unit includes a front panel, located in contact with the card loading portion and constituting a part of the side wall of the apparatus body, and a recess located side by side with the eject lever on the front panel and used in ejecting the eject lever.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a personal computer according to a first embodiment of the present invention;

FIG. 2 is an enlarged perspective view showing a card loading portion and a floppy disc drive portion of the personal computer;

FIG. 3 is a perspective view showing the bottom side of the card loading portion and the floppy disc drive portion; and

FIG. 4 is an enlarged perspective view showing a card loading portion and an optical disc drive portion of a personal computer according to a second embodiment of the invention.

### DETAILED DESCRIPTION OF THE INVENTION

Portable personal computers according to embodiments of the invention will now be described with reference to the accompanying drawings.

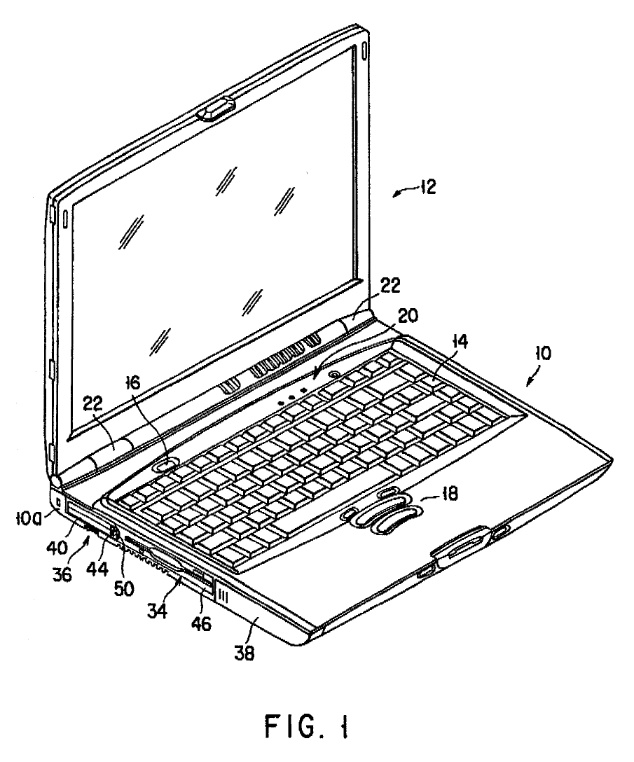

As shown in FIG. 1, a personal computer comprises an apparatus body 10 in the form of a flat rectangular box and a flat rectangular display unit 12. A keyboard 14, power switch 16, click switches 18, indicators 20, etc. are arranged on the top surface of the apparatus body 10. The display unit 12 is supported by means of hinge portions 22 on the rear part of the apparatus body 10 for rocking motion between an open position (shown in FIG. 1) in which the keyboard 14 can be operated and a closed position in which the display unit 12 covers the keyboard.

Arranged in the apparatus body 10, moreover, are drive units such as a floppy disc drive 34, optical disc drive (not shown), etc., a card loading portion 36, a battery pack 38, and various other electronic components.

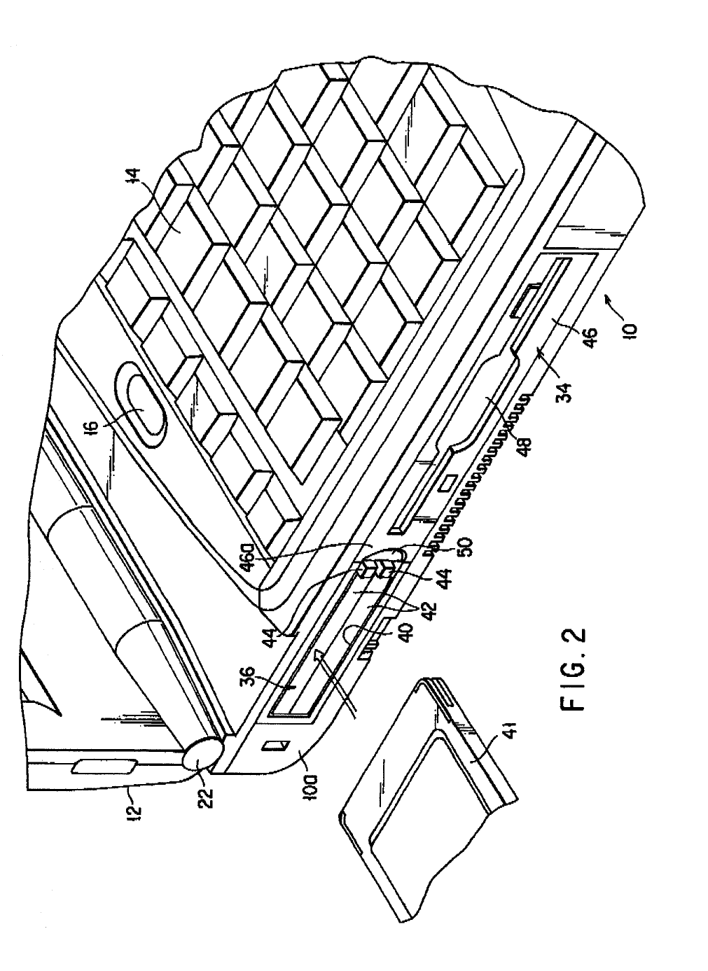

As shown in FIGS. 1 to 3, the card loading portion 36 is provided with a card slot 40, which can be loaded with, for example, two PC cards 41 (based on PCMCIA standards) for use as card-type electronic components. The slot 40 opens in a side wall 10a of the apparatus body 10. The slot 40 has a rectangular opening and opens in a rear end portion of the side wall 10a. The opening is provided with a pair of swingable lids 42 that correspond to the PC cards, individually.

Further, the card loading portion 36 is provided with a pair of eject levers 44 for individually ejecting the PC cards 41 in the card slot 40. The levers 44 are arranged side by side with the card slot 40 on the front end side of the apparatus body 10.

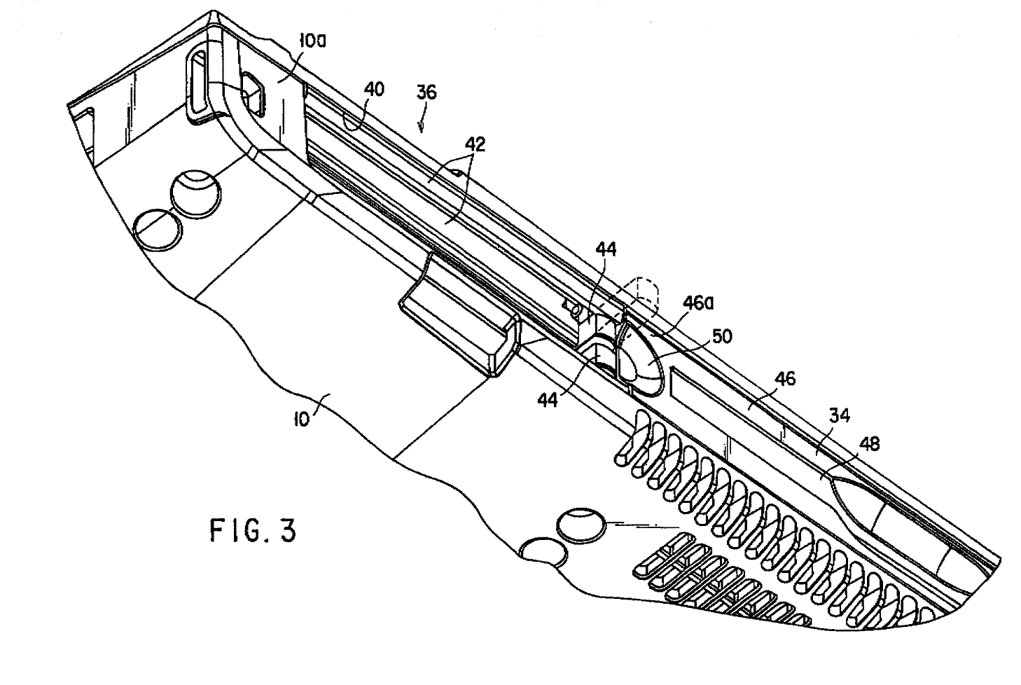

As shown in FIG. 3, the eject levers 44 are push-type eject levers. When the computer is being carried about or is not in operation, the eject levers 44 are pushed in the apparatus body 10 so that their respective distal ends are substantially flush with the side wall 10a. If one of the eject levers 44 is pushed in once, in ejecting one of the PC cards 41 from the corresponding card slot 40, it projects from the side wall of the apparatus body 10, as indicated by two-dot chain line in FIG. 3. The PC card can be ejected as the projected eject lever is pushed in again toward the apparatus body.

As shown in FIGS. 1 to 3, on the other hand, the floppy disc drive 34 is constructed as a unit, and comprises a drive body held in the apparatus body 10 and a front panel 46 of a synthetic resin attached to the front face of the drive body. The front panel 46, which is exposed on the side face of the apparatus body 10, constitutes a part of the side wall 10a.

The front panel 46 of the floppy disc drive 34, having a rectangular shape, is located side by side with the card loading portion 36 without any substantial gap between them. A side edge portion 46a of the front panel 46 on the card loading portion side is situated substantially in contact with the eject levers 44. Further, the front panel 46 is formed having a loading aperture 48 through which a floppy disc can be loaded into and unloaded from the drive body.

Furthermore, a recess 50 for ejecting or depressing the eject levers 44 is formed in the side edge portion 46a of the front panel 46 that adjoins the eject levers, and is situated side by side with the eject levers 44. The recess 50 is substantially in the form of a hemisphere that covers a side edge and the outer surface of the front panel 46 and opens toward the elect levers 44. In ejecting operation, a user can easily push each eject lever 44 into a predetermined position by depressing it while slipping a finger into the recess 50.

According to the personal computer constructed in this manner, each elect lever 44 can be easily pushed in by utilizing the recess 50 in the front panel 46 of the floppy disc drive 34. Further, the side wall 10a of the apparatus body 10 need not secure a space for the recess 50, so that the card loading portion 36 and the front panel 46 of the disc drive 34 can be located close to each other without any substantial gap. Thus, the area of the side wall can be reduced correspondingly, so that the packaging density can be improved, and the apparatus body can be reduced in size.

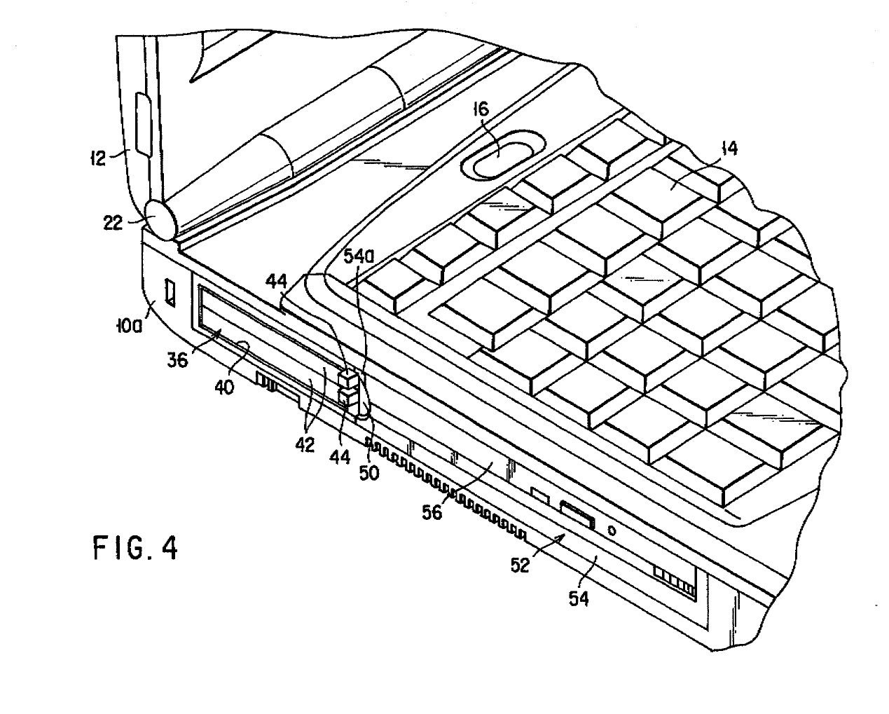

The drive unit that is located side by side with the card loading portion 36 is not limited to the floppy disc drive and may be any other unit member such as an optical disc drive 52, as shown in FIG. 4.

Thus, according to a second embodiment shown in FIG. 4, the optical disc drive 52 is constructed as a unit, and comprises a drive body held in apparatus body 10 and a front panel 54 of a synthetic resin attached to the front face of the drive body. The front panel 54, which is exposed on a side face of the apparatus body 10, constitutes a part of a side wall 10a. Further, the optical disc drive 52 comprises a disc tray 56 for loading and unloading an optical disc. When the disc tray 56 is held in the apparatus body 10, its distal end wall is flush with the front panel 54.

The front panel 54, having a rectangular shape, is located side by side with a card loading portion 36 without any substantial gap between them. A side edge portion 54a of the front panel 54 on the card loading portion side is situated substantially in contact with elect levers 44.

Further, a recess 50 for ejecting or depressing the eject levers 44 is formed in the side edge portion 54a of the front panel 54 and the distal-end-side edge portion of the support pin 56 that adjoin the eject levers, and is situated side by side with the eject levers 44. The recess 50 is substantially in the form of a hemisphere that opens toward the eject levers 44. In ejecting operation, the user can easily push each eject lever 44 into a predetermined position by depressing it while slipping a finger into the recess 50.

Also in the second embodiment constructed in this manner, each eject lever 44 can be easily pushed in by utilizing the recess 50 in the front panel 54 of the optical disc drive 52. Further, the area of the side wall of the apparatus body can be reduced, so that the packaging density can be improved, and the apparatus body can be reduced in size.

The second embodiment shares other configurations with the first embodiment. In the description of these embodiments, therefore, like reference numerals are used to designate like portions, and a detailed description of those portions is not repeated.

It is to be understood, moreover, that the present invention is not limited to the embodiments described above, and that various changes and modifications may be effected therein by one skilled in the art without departing from the scope or spirit of the invention.

For example, the respective locations of the card loading portion and the drive units that are arranged side by side with it are not limited to the positions on the aforesaid side wall of the apparatus body, they may be situated on any other wall portion, such as the other wall, rear wall, or front wall. Further, the shape of the recess 50 is not limited to the hemispherical shape, and may be changed variously as required. Moreover, the card receiving portion can be formed to receive only one card shaped electronic device or more than three card shaped electronic devices, and one or more than three eject levers may be provided.

What is claimed is:

1. An electronic apparatus comprising;
an apparatus body having a wall portion;
a card loading portion including a card slot, formed in the apparatus body, opening in the wall portion of the apparatus body, and configured to receive a card-type electronic component, and an eject lever located side by side with the card slot on the wall portion of the apparatus body and configured to take out the electronic component from the card slot; and
a drive unit provided at the apparatus body, the drive unit including a front panel, located next to the card loading portion and constituting a part of the wall portion, and a recess located side by side with the eject lever on the front panel and capable of receiving a finger.

2. An electronic apparatus according to claim 1, wherein the drive unit includes a floppy disc drive and the front panel attached to the floppy disc drive, the front panel having a loading aperture for a floppy disc.

3. An electronic apparatus according to claim 1, wherein the drive unit includes an optical disc drive, the front panel attached to the optical disc drive, and a disc tray having a distal end wall constituting a part of the front panel.

4. An electronic apparatus according to claim 1, wherein the front panel has a side edge portion situated in contact with the card loading portion, and the recess opens in the surface and the side edge portion of the front panel.

5. An electronic apparatus comprising:
a substantially rectangular apparatus body having a side wall;
a display unit rockably mounted on the apparatus body;
a card loading portion including a card slot, formed in the apparatus body, opening in the side wall, and capable of receiving a card-type electronic component, and a push-type eject lever located side by side with the card slot on the side wall of the apparatus body and configured to take out the electronic component from the card slot; and
a drive unit provided at the apparatus body, the drive unit including a front panel, located next to the card loading portion and constituting a part of the side wall of the apparatus body, and a recess located side by side with the eject lever on the front panel and capable of receiving a finger.

6. An electronic apparatus according to claim 5, wherein the drive unit includes a floppy disc drive and the front panel attached to the floppy disc drive, the front panel having a loading aperture for a floppy disc.

7. An electronic apparatus according to claim 5, wherein the drive unit includes an optical disc drive, the front panel attached to the optical disc drive, and a disc tray having a distal end wall constituting a part of the front panel.

8. An electronic apparatus according to claim 5, wherein the front panel has a side edge portion situated in contact with the card loading portion, and the recess opens in the surface and the side edge portion of the front panel.
